(19) United States
(12) Patent Application Publication
(10) Pub. No.: US 2006/0179659 A1
(43) Pub. Date: Aug. 17, 2006

(54) Rotary type electric shaver

(75) Inventor: Tsuyoshi Nakano, Matsumoto (JP)

Correspondence Address: KODA & ANDROLIA, 2029 CENTURY PARK EAST, SUITE 1140, LOS ANGELES, CA, 90067, US

(73) Assignee: IZUMI PRODUCTS COMPANY

(21) Appl. No.: 11/353,709

(22) Filed: Feb. 14, 2006

(30) Foreign Application Priority Data
Feb. 14, 2005 (JP) 2005-036592

(51) Int. Cl. B26B 19/14

(52) U.S. Cl. 30/43.6

(57) ABSTRACT

A rotary shaver including an outer cutter frame (18) installed on the shaver main body (10), an outer cutter (14) installed in this outer cutter frame (18) and is formed with hair introduction openings (30a, 30b) in ring-shaped thin layer portions (28a, 28b) whose upper surfaces make the shaving surfaces, and an inner cutter (16) that has a cutter body (38) that rotates while making sliding contact from below with the lower surface of the thin layer portions to cut hair that entered the hair introduction opening; wherein the hair introduction openings have a slit shape of substantially constant width and extend in the thin layer portions (28a, 28b) in substantially the radial direction, and they are also curved in a substantially wave shape in their lengthwise direction.

### BACKGROUND OF THE INVENTION

1. Field of the Invention

The present invention relates to a rotary type electric shaver including an outer cutter(s) having a shaving surface on an upper surface of a ring-shaped thin layer portion thereof and an inner cutter(s) rotationally making sliding contact from below with the lower surface of the thin layer portion of the outer cutter(s), thus cutting whiskers (hair) advancing into a hair introduction opening formed in the thin layer portion.

2. Description of the Related Art

In an electric shaver of the type as described above, when the hair introduction opening (hereinafter “slit”) that is a slit or the like formed in the thin layer portion of the outer cutter is firmly pressed against the skin during shaving, the skin enters from the slit and is cut too deeply by the rotating inner cutter and causes a burning feeling in the skin after the shaving. In order to prevent this sort of problem from occurring, it is obvious that the slit width can be made narrow or the outer cutter can be made thick. Here, making the outer cutter thick means increase in dimensions in the thickness direction of the ribs that are on both sides of the slit (the dimension in the direction parallel to the center axis line). However, with a thick outer cutter, a problem occurs that the distance between the skin and the inner cutter is large, and thus another problem occurs that it is not possible to shave whiskers or hair with appropriate depth.

Japanese Patent Application Laid-Open (Kokai) No. H11-4980 discloses a proposal for preventing the above-described problems. As seen from FIG. 5, in this proposal, a plurality of concentric circular inner cutter running grooves 2 (2a, 2b) are formed in the lower surface of ring-shaped thin layer portions 1A and 1B of an outer cutter 1; and the outermost inner cutter running groove 2a is formed with thicker slit-shaped cutter blades (ribs) 3a, and the innermost cutter running groove 2b is formed with thinner slit-shaped blade 3b.

In FIG. 5, the reference numeral 4 is an inner cutter, 4a and 4b are cutter blades of the inner cutter that run in the inner cutter running grooves 2a and 2b while make sliding contact from below with the inner cutter running grooves 2a and 2b. Also, though the thin layer portions 1A and 1B are practically extremely thin, they are shown with their thickness exaggerated for ease of understanding.

Generally, when the upper surface of the thin layer portion 1A that is the shaving surface is moved while being pressed against the shaving part of the face, the skin comes into contact with the outer periphery of the outer cutter, and the pressure force becomes larger at the outer peripheral side of the outer cutter. In the electric shaver taught in Japanese Patent Application Laid-Open (Kokai) No. H11-4980, the peripheral side of the outer cutter is made thick to prevent excessively deep shaving. Furthermore, on the inner peripheral side it is noticeable that the pressure force becomes small. As a result, in the electric shaver of this prior art, the inner peripheral side of the outer cutter is made thin, thus making it possible to perform shaving with appropriate depth on this inner peripheral side.

As seen from the above, the electric shaver of Japanese Patent Application Laid-Open (Kokai) No. H11-4980 hypothesizes a use state in which, when the outer cutter (or the shaver) is moved while being firmly pressed against the skin, the skin wrinkles at the outer peripheral edge of the outer cutter and the pressure force becomes larger. In an actual use state, however, the outer cutter often moves while touching the skin lightly, and a large wrinkle does not occur at the outer peripheral edge of the outer cutter, not providing pleasant shave feeling.

Also, in the electric shaver of Japanese Patent Application Laid-Open (Kokai) No. H11-4980, the hair introduction opening of the outer cutter is of a slit-shape and extends along a straight line that is slightly slanted relative to the radial direction of the outer cutter, and opposite or facing sides of the slit in its lengthwise direction are straight (see FIGS. 3, 6, 7, and 9 of Japanese Patent Application Laid-Open (Kokai) No. H11-4980). Thought not disclosed in this prior art, the cutting edge of the inner cutter (upper edge) and the hair introduction opening of the outer cutter are not parallel, and attempt is made for improving the cutting performance by moving and sliding with a predetermined shearing angle.

However, a hair that enters the hair introduction opening in the above structure is easily pressed and moved by the inner cutter in the radial direction inside the hair introduction opening. In other words, the problem occurs that the hair easily moves around inside the hair introduction opening and is not properly shaved with appropriate depth, not being able to provide sharp and clean cut of the hair.

### BRIEF SUMMARY OF THE INVENTION

The present invention is to overcome the problems described above.

It is, therefore, an object of the present invention to provide a rotary type electric shaver that prevents excessive deep shaving and provides an excellent shaving feeling even when the outer cutter is used while being lightly pressed against the skin.

The above object is accomplished by a unique structure of the present invention for a rotary type electric shaver that includes an outer cutter frame provided on the shaver main body, an outer cutter that is installed in this outer cutter frame and has hair introduction openings in a ring-shaped thin layer portion whose upper surface forms a shaving surface, and an inner cutter that has cutter bodies which make sliding contact with the lower surface of the thin layer portion of the outer cutter and rotate to cut hair that entered the hair introduction opening, and in the present invention,
the hair introduction openings have a slit shape of substantially constant width extending in the thin layer portion in substantially the radial direction, and further the hair introduction openings are curved in a substantially wave shape in their lengthwise direction.

In the above structure, each of the hair introduction openings is of a slit shape which is substantially constant in width and extends in the thin layer portion in substantially the radial direction, and this slit is curved in a substantially wave shape in the lengthwise direction. As a result, if a hair (whiskers) that entered the hair introduction opening is pressed by the cutting edges of the inner cutter and moves in the lengthwise direction of the hair introduction opening, it is temporarily seized by the substantially wave-shaped inner edge of the hair introduction opening, so that movement of the hair is restricted. As a result, hair is cut assuredly by the rotating inner cutter while it is caught by the wave-shaped inner edge of the hair introduction opening.

In addition, since the hair introduction opening is substantially constant in width and is curved in a substantially wave shape, it is difficult for skin to enter the hair introduction opening. As a result, it is possible to make the outer cutter thin; and with an addition of the effect of making it difficult for the hair to move inside the hair introduction opening, it is possible to make appropriate deep shaving.

In the present invention, it is preferable that each of the hair introduction openings be formed along a straight line slanted at a predetermined angle in the direction of rotation of the inner cutter on a circle of constant radius relative to the radial direction of the outer cutter. In other words, the outer peripheral side of the hair introduction opening is displaced farther in the direction of rotation of the inner cutter than the inner peripheral side. As a result, a hair fragment cut by the cutting edge of the inner cutter can easily fly to the outer peripheral side, and it is possible to avoid hair fragments from accumulating at the central area of the inner cutter, making sweeping out of hair fragments easy.

In the above structure, the cutting edge of the inner cutter is positioned on a straight line in substantially the radial direction, and the shearing angle is formed by the cutting edge of the inner cutter and the lengthwise direction of the hair introduction opening and is opened radially outward in an acute angle. With this arrangement, the shaver makes sharp and clean hair cut.

The outer cutter in the present invention can be formed with a plurality of concentric (inside and outside) ring-shaped shaving surfaces, and hair introduction openings (slits) are formed as long ones (first hair introduction openings) that transect both (inside and outside) shaving surfaces in substantially the radial direction. Though this structure would causes the spaces between neighboring hair introduction openings to be excessively large on the outside shaving surface where the perimeter and diameter are long, in the present invention, short hair introduction openings (second hair introduction openings that are smaller in length than the first hair introduction openings) are formed between the neighboring longer hair introduction openings and in only the outside shaving surface.

### BRIEF DESCRIPTION OF THE SEVERAL VIEWS OF THE DRAWINGS

FIG. 1 is a perspective view of the rotary type electric shaver according to one embodiment of the present invention;

FIG. 2 is a cross-sectional side view of a cutter unit of the shaver of the embodiment of the present invention;

FIG. 3 is a top of the outer cutter used in the shaver of the embodiment of the present invention;

FIG. 4 is an enlarged cross-sectional view of a part of the outer cutter defined by circle IV in FIG. 3; and

FIG. 5 shows an outer cutter and an inner cutter in a rotary type electric shaver of prior art.

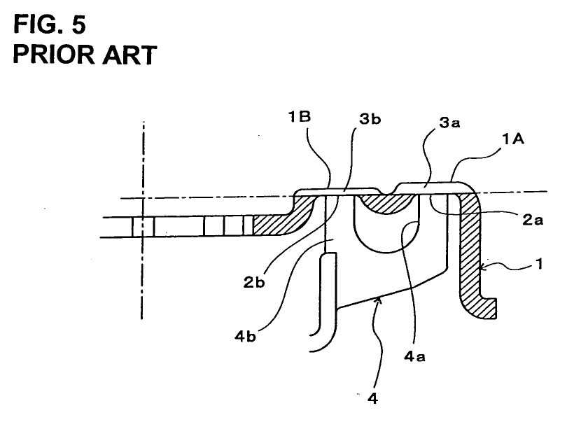

### DETAILED DESCRIPTION OF THE INVENTION

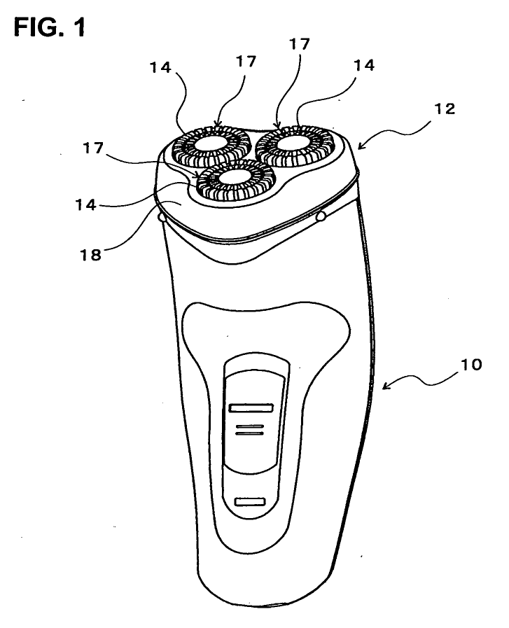

In FIG. 1, the reference numeral 10 is a shaver main body, and 12 is the cutter head openably or detachably attached to the upper part thereof. Three cutter units 17 each formed by an outer cutter 14 and an inner cutter 16 and so forth are installed in the cutter head 12. The outer cutters 14 corresponding to the three cutter units 17 are positioned with their centers at the vertices of an equilateral triangle.

The cutter head 12 has an outer cutter frame 18 (FIG. 1) that is openable or detachable upward relative to the shaver main body 10. The outer cutters 14 are installed in three outer cutter installation holes formed in the outer cutter frame 18. The cutter unit 17 that includes the outer cutter 14 is urged upward or in such a direction that the outer cutter 14 projects upward.

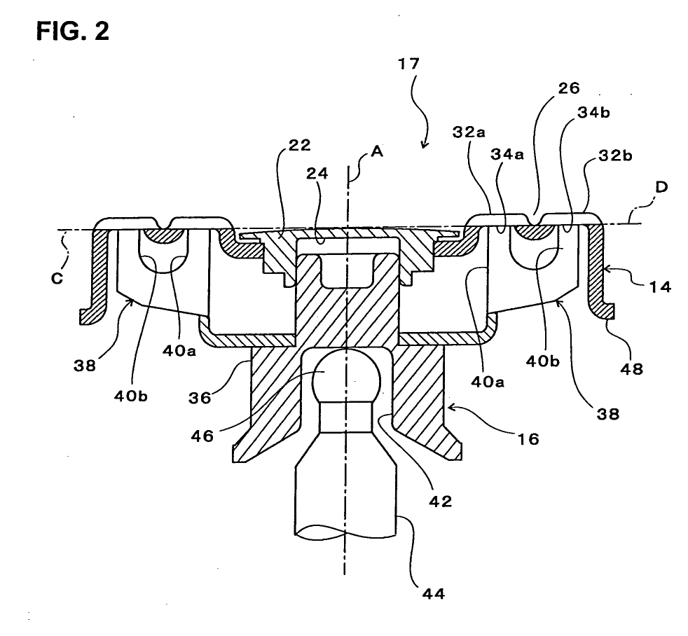

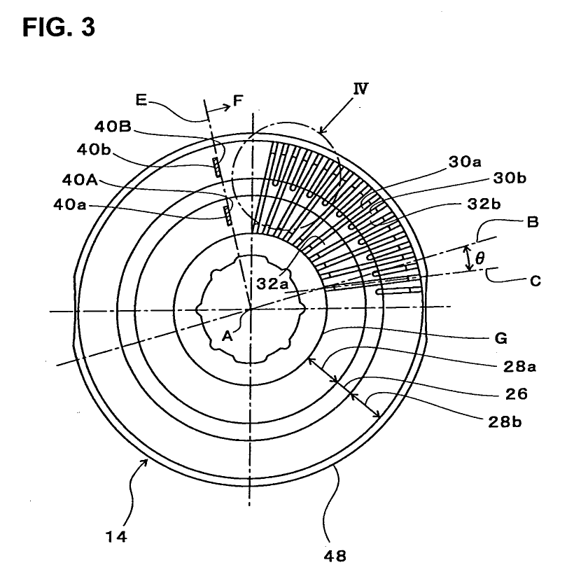

The outer cutter 14 is made of metal in which a metal plate is formed into a substantially shallow bowl shape that is convex upward (see FIGS. 2 and 3). The upper part of the outer cutter 14 is round, and a substantially circular aperture 20 is formed in the center of this circular portion. A cap 22 having an engaging hole 24 in the lower surface is fixed to this circular aperture 20 from above. The tip end of the inner cutter 16, which will be described later, engages the engaging hole 24, preventing axial vibration of the inner cutter 16.

As see from FIG. 2, a single ring-shaped groove 26 is formed in the circular upper part of the outer cutter 14, so that when viewed from above the ring-shaped groove 26 is concentric with the center axis line A that is the rotational center of the inner cutter 16. Two inside and outside ring-shaped thin layer portions 28a and 28b are formed, as seen from FIG. 3, on both sides the ring-shaped groove 26. The upper surfaces of the thin layer portions 28a and 28b make the shaving surfaces of the outer cutter 14, and their lower surfaces make the inner cutter running grooves 34a and 34b.

As shown in FIG. 3, a plurality of slit-shaped long hair introduction openings (first hair introduction openings) 30a, which extend or transect both inside and outside thin layer portions 28a and 28b from the center axis line A, are formed in the outer cutter 14 in substantially the radial direction; and in addition, a plurality of hair introduction openings (second hair introduction openings) 30b that are shorter than the first slit-shaped hair introduction openings 30a are formed so as to extend or transect only the outside thin layer portion 28b. More specifically, the shorter (second) hair introduction openings 30b are disposed to alternate with the longer (first) hair introduction openings 30a so as to be located between neighboring hair introduction openings 30a in the outside thin layer portion 28b.

These hair introduction openings 30a and 30b are formed along a straight line C which is slanted by a predetermined angle θ in the rotational direction F of the inner cutter 16 on a circle G of constant radius with respect to a straight line B that extend in the radial direction and passes through the center axis line A in FIG. 3.

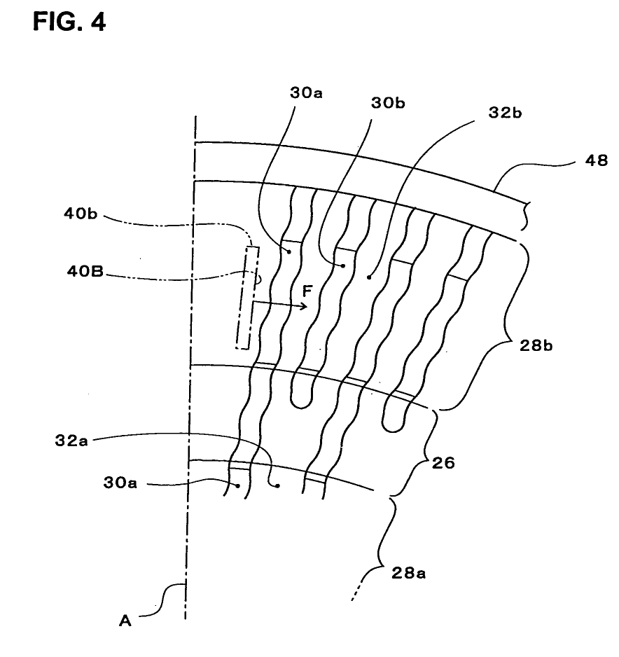

In addition, these hair introduction openings 30a and 30b are of constant width and are curved in a substantially wave shape in the lengthwise (or longitudinal) direction as seen from FIG. 4.

The portions that are between adjacent hair introduction openings 30a and 30a on the inside thin layer portion 28a form ribs 32a, and portions between adjacent hair introduction openings 30b and 30b on the outside thin layer portion 28b form ribs 32b; and the lower surfaces of these ribs 32a and 32b work together with the inner cutter 16 and form a cutter that cuts the hair (whiskers). In other words, neighboring two ribs 32a define the hair introduction holes (slits) 30a and neighboring two ribs 32a and 32b define the hair introduction holes (slits) 30b; and the lower surfaces of these ribs 32a and 32b cut the hair in cooperation with the rotating inner cutter 14.

The upper surface of the outer cutter 14—more specifically, the upper surface of the ribs 32a and 32b—is on a plane orthogonal to the center axis line A (the center axis line A being perpendicular) as shown in FIG. 2; in other words, the upper surfaces of the ribs 32a and 32b are flat.

The lower surface of the thin layer portions 28a and 28b of the outer cutter 14 (more specifically, the lower surface of ribs 32a and 32b) make inner cutter running grooves (ring-shaped tracks) 34a and 34b, respectively; and these inner cutter running grooves 34a and 34b are designed such that when seen from below (from the inside) the inner surfaces (bottom surfaces) of the inner cutter running grooves 34a and 34b are located on a surface demarcated by a plane D that is orthogonal to the center axis line A. The plane D matches or corresponds to the lower surface of the ribs 32a and 32b. The lower surfaces of the ribs 32a and 32b are grinded by a whetstone, forming cutting edges at the lower edges of the ribs 32a and 32b.

The inner cutter 16 is comprised of a resin boss element 36 that opens downward and a plurality of cutter bodies 38 surrounding the boss element 36 and equidistantly fixed circumferentially. The plurality of cutter bodies 38 can be formed so as to be connected to form a ring shape. The upper portion of each one of the cutter bodies 38 divides into a bifurcated shape, forming two cutter blades 40a and 40b that make respectively sliding contact from below with the inner cutter running grooves (tracks) 34a and 34b of the outer cutter 14. The upper edges of the cutter blades 40a and 40b form cutting edges—specifically, cutting edges 40A and 40B—that are grinded horizontally along the above-described plane D.

The cutter blades 40a and 40b of the inner cutter are, as shown in FIG. 3, provided so as to be on a straight line E in the radial direction that passes through the center axis line A. Strictly speaking, the inner cutter 16 rotates in clockwise direction F in FIG. 3; and the upper edges of the cutter blades 40a and 40b on this rotational direction side F are the cutting edges 40A and 40B and are positioned on the straight line E. Accordingly, when the inner cutter 16 rotates in direction F, the shearing angle formed between the cutting edges 40A and 40B of the cutter blades 40a and 40b and the hair introduction openings 30a and 30b is equal to the slant angle θ of hair introduction openings 30a and 30b on the circle G of constant radius. The intersection positions between the cutting edges 40A and 40B and the hair introduction openings 30a and 30b move radially outward as the inner cutter 16 makes its rotation; as a result, the shearing angle (=θ) changes with the rotation of the inner cutter 16; and since such shearing angle is an acute angle that opens radially outward, the shaver (or the inner and outer cutters) makes sharp and clean cut of the hair.

In FIG. 2, an engagement hole 42 that opens downward and has a quadrilateral shape when seen in plan view is formed in the boss element 36, and a drive shaft 44 that projects from the shaver main body 10 engages this engagement hole 42. A quadrilateral spherical engagement head 46 is formed in the upper end of the drive shaft 44 and enters the engagement hole 42 of the boss element 36 from below. The drive shaft 44 is rotationally driven by a motor (not shown in the drawing) housed inside the shaver main body 10 and rotates the inner cutter 16.

The drive shaft 44 has a property of reciprocating motion in the upward projecting direction and pushes the inner cutter 16 upward. As a result, the cutter blades 40a and 40b of the inner cutter 16 elastically press the inner cutter running grooves 34a and 34b of the outer cutter 14 from below.

Furthermore, a flange 48 is formed along the lower periphery of the outer cutter 14 s as to project radially outward. The flange 48 of the outer cutter 14 engages inside an outer cutter installation hole (not shown in the drawing) formed in the outer cutter frame 18 from below. Accordingly, the cutter unit 17 that is comprised of the outer cutter 14 and the inner cutter 16 can sink downward relative to the outer cutter frame 18 with elasticity.

As seen from the above, in the shaver of the present invention, the hair introduction openings 30a and 30b of the outer cutter have a constant width and curved in a substantially wave shape in their lengthwise direction. Accordingly, the hair that enters the hair introduction openings 30a and 30b is temporarily seized by the edge of the wave shape of the hair introduction openings 30a and 30b and cut by the inner cutter 16. In addition, since the hair introduction openings 30a and 30b are curved in a substantially wave shape, it is difficult for skin to enter the hair introduction openings. Therefore, the thickness of the outer cutter 14—specifically, the thickness of the ribs 32a and 32b—can be given a small dimension in the direction parallel to the center axis line A, and it is possible to shave with appropriate depth.

Needless to say, the present invention is not limited to the structures described above. For example, the wave shape of the hair introduction openings 30a and 30b can be of a sine curve, a shape with regular or irregular roughness, a saw-tooth shape, etc. In order to protect the skin, it is preferable that the wave shape be as smooth as possible. This type of outer cutter can be obtained by, for instance, etching.

The outer cutter is not limited to one that has two thin layer portions 28a and 28b and inner cutter running grooves 34a and 34b; and it can be provided with a single set of the thin layer portion and inner cutter groove or with three or more sets of the thin layer portions and inner cutter grooves. Also, the shaving surface(s) on the upper surface of the outer cutter is not limited to that which is on a flat plane; and it can be formed in a curved surface that is convex upward or downward in vertical cross-section taken in a plane in the radial direction of the outer cuter and including the center axis line A.

1. A rotary type electric shaver comprising an outer cutter frame that is provided on a shaver main body, an outer cutter that is installed in said outer cutter frame and has hair introduction openings in its ring-shaped thin layer portion whose upper surface forms a shaving surface, and an inner cutter that has cutter bodies which make sliding contact with a lower surface of said thin layer portion and rotate to cut hair that entered said hair introduction openings, wherein
said hair introduction openings has a slit shape of substantially constant width extending in said thin layer portion in substantially a radial direction thereof, said hair introduction openings having in a substantially wave shape in a lengthwise direction thereof.

2. The rotary type electric shaver according to claim 1, wherein each of said hair introduction openings is formed along a straight line which is slanted at a predetermined angle in a direction of rotation of said inner cutter relative to a radial direction of said outer cutter.

3. The rotary type electric shaver according to claim 2, wherein
a cutting edge formed on said inner cutter that makes sliding contact with said lower surface of said thin layer portion is on a straight line which is in substantially a radial direction of said outer cutter, and
a shearing angle, which is formed by said cutting edge of said inner cutter and a lengthwise direction of said hair introduction openings and opens radially outward, is an acute angle.

4. The rotary type electric shaver according to claim 1, wherein
said outer cutter is provided with a plurality of ring-shaped and concentric thin layer portions, and
said hair introduction openings comprises first hair introduction openings and second hair introduction openings, said first hair introduction openings transecting said plurality of thin layer portions in substantially a radial direction of said outer cutter, and said second hair introduction openings transecting one of said plurality of thin layer portions and being provided between neighboring first hair introduction openings.
